(19) United States
(12) Patent Application Publication
(10) Pub. No.: US 2002/0115477 A1
(43) Pub. Date: Aug. 22, 2002

(54) Portable high speed internet access device with scrolling

(76) Inventor: Raja Singh, Montreal (CA)

Correspondence Address: RAJA SINGH TULI, 555 RENE LEVESQUE WEST, SUITE 1130, MONTREAL, QC, H2Z1B1, CA

(21) Appl. No.: 09/781,265

(22) Filed: Feb. 13, 2001

(51) Int. Cl. H04M 1/00

(52) U.S. Cl. 455/566; 455/557; 455/575

(57) ABSTRACT

The invention discloses a portable remote device that connects wirelessly to the internet or other sources via a host computer which runs a browser, taking information received and renders it onto a virtual display in memory. This information is directed to software which reduces the color depth, compresses and sends it to the portable device, which decompresses and stores it into memory for displaying. The information captured and sent to the remote device is limited to the size of the browser's window, which may be considerably smaller than the image in the virtual display. The browser automatically scrolls to other parts of the image to capture it entirely, sending segments simultaneously to other software responsible for color depth reduction and compression, whilst it scrolls to other segments. The host computer keeps a record of credit card details for each user on file, hence there is no encryption required between the host and remote device, as the host automatically inserts credit card details from its database in the appropriate location for each credit card purchase over the Internet.

### PRIOR ART

The background of the present invention includes U.S. Pat. No. 5,925,103, Internet Access Device, which describes an improved Internet access system, vastly different from the present invention. Other prior art would include palm top computers and hand-held computers that have limited processing power due to design restrictions. Thus, these portable computers are much slower for accessing the Internet and World Wide Web.

The present invention enhances the host computer's processing speed, data transfer and retrieval to and from a portable hand held device, with the aid of specialized embedded software in the host computer. The result is a cost effective Internet access solution. The present invention also provides an enhanced method of automatically scrolling a web page image on the browser and sending blocks of information to the remote device. Further provision for credit card transactions is made with secured credit card details kept at the host computer.

### SUMMARY

It is an object of the present invention to disclose a portable device that can access the Internet and World Wide Web, at extremely low costs. It is another object of the present invention to provide a secured image transfer between the host computer and the portable device, with off line viewing capabilities.

The present invention discloses a portable device that connects to a cellular telephone. Thus, a means is provided for the device to have a wireless connection to the Internet via a host computer that runs a browser, which takes information received from the Internet or other sources and renders it onto a virtual display in its memory. This information is directed to software, which reduces the color depth of the information to a lower depth color image. This reduced image is then compressed by another software and sent to the portable device of the invention, for displaying to the user. Hence, the portable device receives the compressed image, stores it into memory, and decompresses it prior to display for the user. Thus, the user views a bit map image of a Web page.

In another instance, the browser itself may render the information onto a virtual display in its memory with a reduced color depth, and also compresses this reduced virtual display, which eventually gets sent to the portable device. This eliminates the need for other software to perform the same tasks.

The image displayed in the browser's window is captured and sent to another “image engine” software which reduces the color depth and compresses the image, which is then sent to the portable device for displaying to the user. Since the browser's window is usually smaller than the entire image rendered onto a virtual display in its memory, in order to view the entire image on the portable device, the browser traverses the entire image automatically, capturing the image in its window at each location, which is eventually sent to the remote device to be stored in memory. Hence, as the user scrolls to an area outside the display 5 screen on the remote device or approaches the screen boundary, the new area is decompressed from memory to be displayed. Capturing of images, color depth reduction, compression, and sending of the image to the remote device can all occur simultaneously as the browser moves to other areas of the virtual display.

To reduce the risk of intercepted communications containing valuable details such as credit card information, the host computer would contain the user's credit card information in an internal or external database. To further reduce the cost of the remote device, encryption and decryption engines typically used for secured credit card transactions are removed from the device. When the user wishes to make a credit card transaction and all items are selected for purchasing, upon clicking on the ok icon a message is sent to the host computer which inserts the purchase details along with the credit card information from the database into the virtual display in memory. Hence, the web page image is modified and this is sent back to the web server using encryption and decryption between the host computer and the web server. A refreshed web page would be sent back to the host computer usually confirming the transaction.

### DETAILED DESCRIPTION OF THE DRAWINGS

The invention is described in more detail below with respect to an illustrative embodiment shown in the accompanying drawings in which:

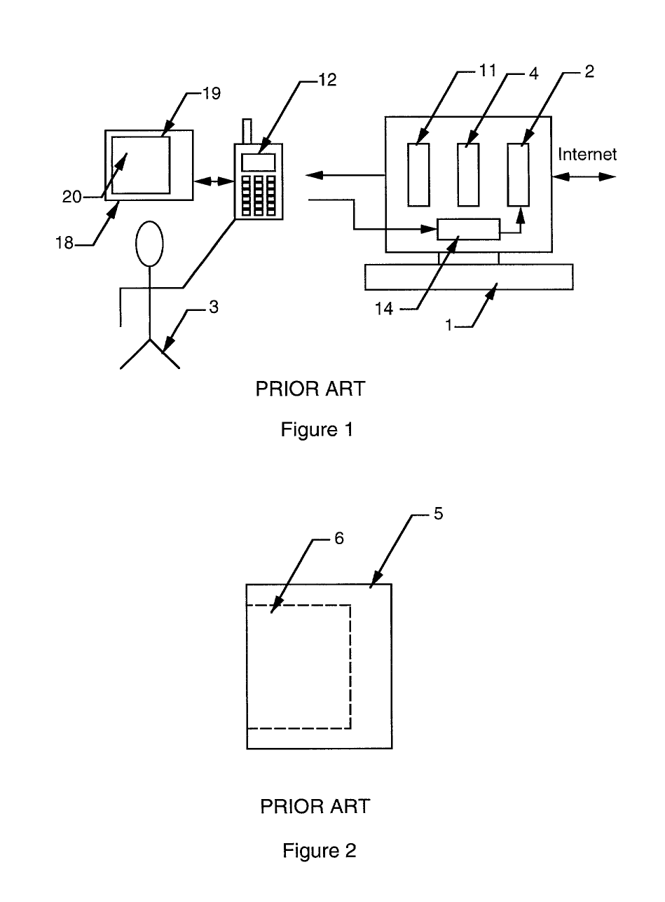

FIG. 1 illustrates elements in the host computer, which communicates with a remote user and the device of the invention, in accordance with prior art.

FIG. 2 illustrates the image to be displayed compared with the displayable area of a browser window, in accordance with prior art.

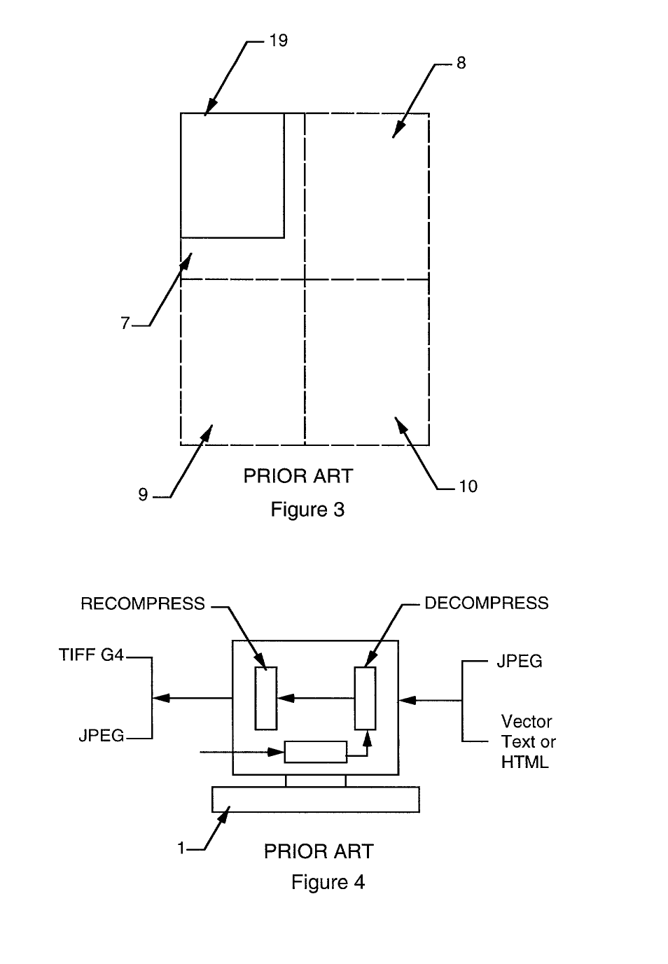

FIG. 3 shows a typical subdivision of the image to be displayed, in accordance with prior art.

FIG. 4 illustrates file formats received and sent by the host computer, in accordance with prior art.

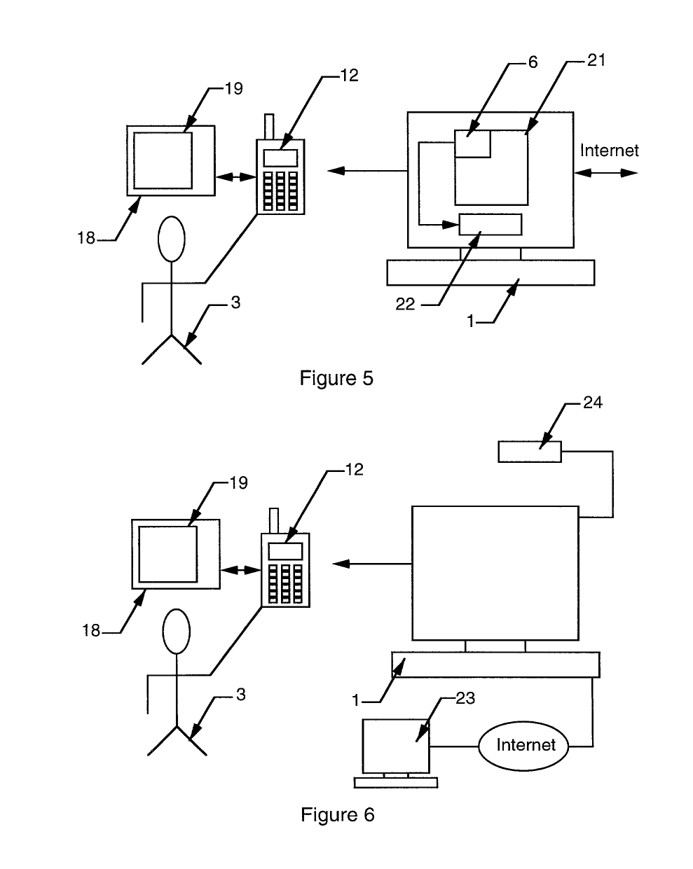

FIG. 5 illustrates the image in the browser window captured by another software to be sent to the remote device.

FIG. 6 illustrates a method of secured credit card purchases on the remote device without encryption or decryption of sensitive information at the remote device.

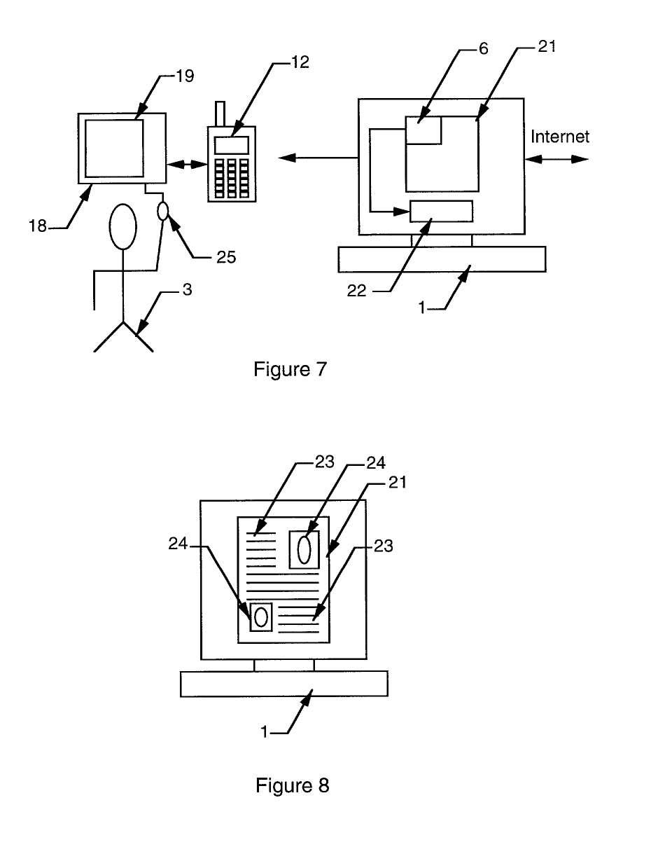

FIG. 7 illustrates a method of a dragging event on the remote device.

FIG. 8 illustrates the image in the virtual display subdivided into blocks of text and graphics.

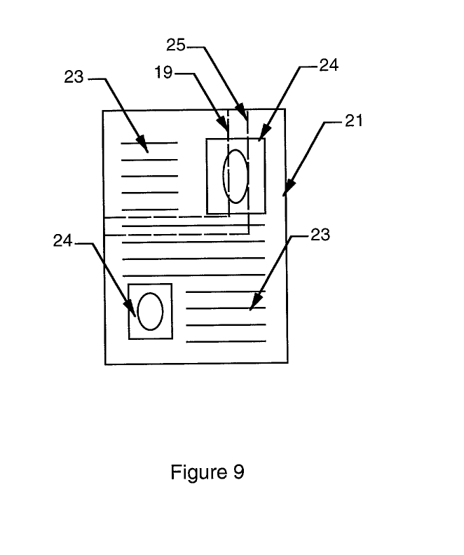

FIG. 9 illustrates portions of the image in the virtual display sent in order of priority.

### DETAILED DESCRIPTION OF THE PRESENT INVENTION

To facilitate description, any numeral identifying an element in one figure will represent the same element in any other figure.

The principal embodiment of the present invention aims to provide a portable device that allows a user to access the Internet or the World Wide Web (WWW), which is a device similar to a portable computer. It is another aim of the present invention, to provide a method to develop a cost competitive device. It is a further aim of the present invention, to provide a secured means of credit card purchases over the Internet.

Currently, existing portable devices such as the Palm Pilot VII and Windows CE type devices contain an operating system, and within the operating system a mini-browser to interpret information received from the WWW or Internet and then display this information on the screen. This requires a powerful microprocessor unlike the present invention.

Prior art of application Ser. No. 09/496,172 is disclosed in FIG. 1. A host computer 1 is depicted which is connected to the Internet, and that host computer receives information from outside in the form of HTML or JAVA or other formats, required to generate a web page. Running in the host computer, is a browser program 2 that takes all information received from outside and renders it onto a virtual display in its memory, hence a bitmap is made out of it. When a remote user 3 requests to view a Web page (or electronic message, etc.) a message is sent to the host computer 1 which receives HTML, JAVA, or other types of information from outside the computer (as information may be gathered from a variety of different sources) and the browser program 2 takes all information received from outside and renders it onto a virtual display in its memory. What is therefore rendered in the memory is a web page and this information is directed to another software 4, which reduces the color depth of the information (i.e. the entire image comprising graphics and text) which is usually received in 24 bit color, subsequently reduced to a black and white bit map or raster image, in the preferred embodiment. Even though text may appear in black and white, the entire image may be 24 bit color which is reduced to black and white. This reduced image is then compressed entirely using a loss-less method of compression by software 11, using G3 or G4 methods in the preferred embodiment. This compressed image is then sent through a port in the host computer 1, in the preferred embodiment, to the cellular telephone 12 of FIG. 1, which is connected to the portable high speed internet access device 18 of the invention. The portable device 18, which contains a display screen 20 with a transparent touch panel and related microelectronics, receives the compressed image, decompresses it, stores it into internal memory, and displays it for viewing to the user 3.

In another embodiment of the prior art, the cellular phone 12 of FIG. 1 can be replaced by a wire less modem which is connected to the portable high speed internet access device 18 of the invention. This enables the portable device 18 to receive the compressed image, decompresses it, store it into internal memory, and display it for viewing by the user 3.

In another embodiment of the prior art, the cellular phone 12 of FIG. 1 can be replaced by a LAND line or PSTN which is connected to the portable high speed internet access device 18 of the invention. This enables the portable device 18 to receive the compressed image, decompresses it, store it into internal memory, and display it for viewing by the user 3.

In another embodiment of the prior art, the portable device 18, receives the compressed image, and stores the compressed image into internal memory. The image is decompressed prior to displaying for the user 3 when desired.

In other aspects of prior art, the image 5, as shown in FIG. 2, contains the information that would normally be displayed on a single Web page. As can be seen in FIG. 2, the image 5 of the web page that is rendered by the browser 2 onto a virtual display in the memory is usually larger than the virtual window 6 of the browser. The entire image 5 of the web page is sent to the portable device 18, to be displayed. The window 6 of the browser 2 running in the host computer 1 is set to be the same size as the display window 19 of the portable device 18, because the portable device's display window is small, and most likely the web page is larger than the window of the browser in the host computer. The reason for setting the browser's window to be approximately the same size as the portable device's window is for formatting purposes, so that text can be formatted to comfortably fit in the portable device's window to be better displayed, without being cut off at the edges or other display related problems, making it easy to read.

A CPU resident in the portable device 18 therefore has the ability to decompress a bit map or raster image that may be larger than the size of the display and allow the user to traverse this bit map or raster image on the portable device. The primary method of traversing the image is through conventional scroll bars positioned at the sides of the image. However, buttons or icons may also be used to scroll on the portable device, to enable the user to move the web page relative to the display of the portable device. The CPU present in the portable device performs all scrolling functions, even though messages are sent to the host computer informing it of each scroll instruction. This allows the host computer to keep a track of the location of the portable device's display screen with respect to the web page.

The host computer receives vector information or compressed data from outside in the form of HTML, JPEG, etc., which is displayed on a web page. That image, in whole or parts, is recompressed and sent to the portable device. The recompressed data format sent to the portable device, is not necessarily in the same format as the compressed data format first received by the host computer, as illustrated in FIG. 4. For example, the incoming data from a Web page may be in the form of JPEG which is decompressed and displayed on the browser 2. This data is recompressed and sent to the portable device but can be in the form of TIFF G4 or other formats, and not necessarily JPEG as initially received.

Another embodiment involves the host computer receiving vector information such as HTML or text and then rasterizing it to bit map format. It can then shown in memory through the virtual browser and is recompressed through a “loss less” method and sent to the portable device.

The image 5 is further divided into sections 7, 8, 9, and 10, as shown in FIG. 3. The image is divided after the bitmap or raster is created. The reason for the division is for the purpose of display priority on the user's display. The image 5 is then sent to another program 11 running on the host computer 1 (FIG. 1), which compresses the image using a loss-less compression method. The compression method may be group 3 or group 4, or another method. The information is received by a portable device 18 that has the ability to display an image, in its display window 19. The information is decompressed and displayed in the order of priority such that part of image 7, which substantially or completely covers the displayable area 19 of the portable device, is decompressed and displayed first and then sequentially the portions 8, 9, 10 of the image are decompressed and stored in an internal memory of the portable device to be displayed later when the user scrolls up, down, or sideways to these parts of the image.

In other prior art, the browser program 2 takes information received from outside and renders it onto a virtual display in its memory, but not at the high depth of color as originally received. The browser 2 renders the image in a reduced depth of color, such as a black and white image, in the preferred embodiment. Hence, the software 4 is not required for reducing the color depth of the information as the browser program 2 also performs this task. This reduced image is then compressed by the browser program 2 and sent to the portable high speed Internet access device 18 of the invention. The portable device 18, which contains a display screen 20 with a transparent touch panel and related microelectronics, receives the compressed image, decompresses it, stores it into internal memory, and displays it for viewing to the user 3.

In a principle embodiment of the present invention with reference to FIG. 5, a web page image 21 in the virtual display is featured, which is bigger than the browser window 6 within the Host Computer 1. The browser's window 6 is set to be approximately the same size as the portable device's window 19, and the main reason is for formatting purposes, so that text can be formatted to comfortably fit in the portable device's window 19 to be better displayed, without being cut off at the left or right edges, making it easy to read. In the regular browser, when the width of the window is reduced some pages are automatically formatted so that they fit left-to-right justified in that window, and the user can view the entire image by only having to scroll up and down, without also having to scroll left-to-right. In many of the pages that are displayed, when they are formatted on the web page they get formatted such that the left-to-right formatting fits within the window of the browser so that the user does not have to scroll left-to-right, but only has to scroll up and down. The browser 2 of FIG. 1, is connected to another software 22 which captures the image in the browser window 6, which is eventually sent to the portable device 18, to be stored in memory and displayed to a user 3. However, the software 22 is somewhat restricted in only being able to see the portion of the image displayed in the browser window 6. Hence, in order to capture the entire image of the web page 21, the software 22 must instruct the browser to scroll to other segments of the web page to capture all other portions of the image. The software 22 would reassemble the captured segments of the web page in a different location on the host computer 1, before it reduces the assembled image in color depth, compresses it, and sends it to the remote device 18.

In another embodiment of the invention, the software 22 receives the captured segments from the browser window 6 already reduced in color depth by the browser 2 of FIG. 1. The software 22 would then compress each segment and send it to the portable device 18 as blocks of information, which are assembled and stored in memory on the portable device. The browser 2 sends segments of the web page 21 from the browser's window 6 already reduced in color depth to the software 22, which simultaneously compresses each segment and sends it to the remote device 18. Each segment viewed by the user on the display screen 19 is already decompressed by the remote device 18 and as the user scrolls to new segments they are already decompressed from memory ready for viewing.

In a further embodiment of the invention, the browser goes to a first part of the image as illustrated in FIG. 5, and captures the segment of the image in the browser's window 6, then sends this segment to software 22 which reduces the color depth and compresses the image, then sends this compressed image to the portable remote device. During the period that the compressed image is being sent to the remote device, the browser automatically scrolls to other segments of the image which are captured and sent in turn to the remote device in a similar fashion, in the preferred embodiment. In another embodiment, after the segment of the image in the browser's window 6 is reduced, compressed and sent to the remote device by software 22, then the browser automatically scrolls to another segment of the image which is captured and sent in turn to the remote device, in a similar fashion. The browser would scroll one by one to all areas of the image in order to send it entirely to the remote device, where all segments of the image comprising the entire image are received, decompressed, assembled in order and stored in memory to be displayed to the user. When the user scrolls to another part of the page on the portable device, a message is sent to the host computer informing of the new location that the user has scrolled to, and incase this part of the image is not sent already, the browser immediately moves to this exact location and captures the segment of the image in the browser's window 6, then sends this segment to software 22 which reduces the color depth and compresses the image, then sends this compressed image to the portable remote device to be displayed. The browser would scroll one by one to all areas of the image around this new location and sends these areas as a priority over other areas to the remote device. The browser would eventually scroll to all parts of the image, which would all be captured and sent to the remote device for displaying.

In another embodiment of the invention with reference to FIG. 6, the host computer 1 is connected to the Internet, at the other end of which lies a web server 23. For the purpose of secured transactions, such as credit card purchases over the Internet, encryption and decryption engines need to be placed at both ends of the communication line. However, it is expensive to have such an encryption and decryption engine in the remote device, so this embodiment provides the means to avoid this. The user would have all credit card details stored in a file on the host computer 1, or in an external database 24 accessible by the host computer. The host computer would know at all times which user is logged on to the Internet, and when a user wants to make a purchase over the Internet, the host computer would be able to retrieve all confidential credit card details on file for any user and automatically insert them in the appropriate location on the web page, after the user has selected items desired and clicked ok to purchase. Hence, the host computer would enter the identical information selected on the display screen of the remote device into the exact location in the virtual display in its memory, together with the user's credit card details on file in the database. This modified web page image is sent back to the web server and a refreshed web page response is sent back to the host computer, usually confirming the transaction. Throughout this transaction, no credit card details would be relayed between the remote device 18 and the host computer 1, providing a secured means for purchasing over the Internet. The host computer 1 would have encryption and decryption engines installed to provide maximum security when relaying the web page complete with credit card details to the web server 23 over the Internet, and also in receiving detailed information from the web server. There may be other ways in which the host computer would send credit card details to the web server, as normally done for credit card transactions. Hence in another embodiment, the host computer would communicate with the web site in the format preferred by that particular web site, for credit card details to be transferred successfully.

In a further embodiment of the invention with reference to FIG. 7, any event that involves a dragging event is performed by the host computer after the user has completed the event. In particular, when the user 3 wishes to move an object or select characters on the display screen 19 of the remote device 18, the user would usually click down, drag and then click up or release on a mouse 25 or pointing device connected to the remote device 18. The click down and click up locations on the display screen are sent as a message from the remote device to the host computer 1, and the host computer would insert these commands in the exact locations in the browser. A refreshed image is then rendered in the virtual display in memory at the host computer 1 and then sent to the remote device 18 to be displayed. The host computer does not send any image back to the remote device until the click up is performed and the image is refreshed.

In another embodiment of the present invention, the browser 2 renders the entire image 21 in its memory with the formatting exactly as the user would see it. In this particular method of formatting, when the user sees the image on a normal computer screen (not per this invention), that is precisely the way it is rendered into memory per the present invention. Unlike other prior art that reformats different parts of the image to send to a remote device, the present invention renders the image exactly the way it is. In the preferred embodiment, the browser 2 identifies parts of the image that need to be reduced or compressed differently. In an alternate embodiment, the software 22 identifies parts of the image that need to be reduced or compressed differently. For parts of the image that contain pictures or graphics, the depth is reduced from 24 bit to 8 bit (or 16 million colors to 256 colors) and also gets compressed by software 22 using a method such as JPEG, which are normally lossy, or any other lossy method of compression. For other parts of the image that contain text, the depth gets reduced from 24 bit to 3 bit and also gets compressed by software 22 using a method such as G3 or G4, which are normally loss less, or any other loss less method of compression. Thereafter, the compressed images are sent to the portable remote device 18 with a top priority placed on lower color depth or text portions, which are sent first. Upon receiving the compressed images, the remote device 18 decompresses, stores into memory and displays these images to the user, first displaying the text portions followed by graphics.

In a another embodiment of the invention as illustrated in FIG. 8, the image 21 that is rendered by the browser 2 into memory is subdivided into blocks containing text 23 and blocks containing graphics 24. The locations of these blocks containing text and graphics, 23 & 24, are sent from the host computer 1 to the portable device 18 to assist in the reconstruction of the image at the portable device. When the block of information is sent, the location of the block is sent to tell the remote device where to assemble this block in the image. However, a top priority is placed on parts of the image, both text and graphics, that appear in the window of the browser which eventually appear on the display screen 19 of the remote device 18, as these portions are reduced, compressed and sent first from the host computer 1 to be displayed first on the remote device. The next priority is placed on the lower color depth images such as text outside the window of the browser, which are then reduced, compressed and sent to the portable device. The higher color depth images such as graphics outside the window of the browser are sent after text, all of which is stored into memory on the portable device.

In another embodiment of the invention with further reference to FIG. 8, the complete image 21 comprising text portions 23 and graphics portions 24 gets rendered into memory by the browser, and is reduced entirely to 3 bit depth of color which is then compressed and sent to the portable device. The image is received at the portable device and decompressed, for displaying to the user. After the 3 bit image is sent from the host computer, then certain portions of the image that need to be of a higher depth of color such as graphics 24, are reduced to 8 bit depth of color and are compressed and sent to the remote device. These graphic portions of a higher color depth are received at the remote device, decompressed and placed exactly over the same 3 bit color images, thus improving the quality of the graphics portions of the display. A priority is placed on sending of images from the host computer to the remote device. With further reference to FIG. 9, the image 21 which is rendered into memory by the browser, contains portions of text 23 and portions of graphics 24.

The display screen area 19 of the remote device, may contain portions of text and graphics with the browser's window also set to be this size. An area 25, slightly larger than area 19, is selected whereby all portions of text and graphics within area 25 are reduced in color depth to 3 bit, compressed and sent to the remote device as a top priority. An area slightly larger than the display screen size is selected should the user wish to scroll around the displayed area. This area 25 is decompressed and stored into memory on the remote device 18, with area 19 displayed to the user. Any portion of graphics 24 within area 25 is reduced in color depth to 8 bit, compressed and sent to the remote device as a second priority. These graphic portions of a higher 8 bit color depth are received at the remote device, decompressed and placed exactly over the corresponding 3 bit color images, thus improving the quality of the graphics portions of the displayed area. The next priority would be placed in taking all other portions of text and graphics outside area 25 of the image 21, reducing in color depth to 3 bit, compressing and sending these to the remote device. The last priority placed in taking all portions outside area 25 of the image 21, that need to be of a higher depth of color such as graphics 24, reducing to 8 bit depth of color and compressing and sending these to the remote device 18.

What is claimed:

1 A host computer which receives information from an outside source, contains a browser with a window which renders this information onto a virtual display in its memory, whereby a software program reduces the color depth of the rendered virtual display, compresses this reduced virtual display and sends it to a remote device capable of receiving, decompressing, storing into memory and displaying it to a user.

2. A host computer which receives information from an outside source, contains a browser with a window which renders this information onto a virtual display in its memory and also reduces the color depth, compresses this reduced virtual display and sends it to a remote device which is capable of receiving, decompressing, storing into memory and displaying it to a user.

3. A device as claimed in claim 1 or 2 such that the browser contains a window whereby a portion of the virtual display is displayed as an image in the browser's window and is captured by a software which reduces the color depth, compresses it and sends it to the remote device, with the browser's window automatically scrolling to other parts of the virtual display during the period the image is sent to the remote device, whereby all parts of the image are captured and sent to the remote device.

4. A device as claimed in claim 1 or 2 such that the browser contains a window whereby a portion of the virtual display is displayed as an image in the browser's window and is captured by a software which reduces the color depth, compresses it and sends it to the remote device, with the browser's window automatically scrolling to other parts of the virtual display after the image has been sent to the remote device, whereby all parts of the image are captured and sent to the remote device.

5. A device as claimed in claim 1 or 2 whereby the host computer contains information in an internal or external data base such that the remote device may instruct the host computer to insert parts of this information into specific locations on the virtual display, in conjunction with other information selected by the user that appears on a display screen of the remote device, which is all sent to the source and a refreshed information is received by the host computer from said source.

6. A device as claimed in claim 1 or 2 such that the remote device comprises a mouse or pointing device connected to it which is used to select or move objects on a display screen, whereby the click down and click up command locations on the display screen are sent as a message to the host computer which inserts these commands in the exact locations on the virtual display, which is sent to the source and a refreshed information is received by the host computer from said source.

7. A device as claimed in claim 1 or 2 such that different parts of the image after being rendered are reduced in color to different amounts and compressed and sent to the remote device.
